(19) United States
(12) Patent Application Publication
(10) Pub. No.: US 2022/0371476 A1
(43) Pub. Date: Nov. 24, 2022

(54) CONTROL ARRANGEMENT FOR A DRIVE ARRANGEMENT

(71) Applicant: Brose Fahrzeugteile SE & Co. Kommanditgesellschaft, Bamberg, Bamberg (DE)

(72) Inventors: Matthias GEMPEL, Bamberg (DE); Peter HORN, Kemmern (DE); Thomas WEINGÄRTNER, Lichteneiche (DE); Christian HERRMANN, Großheirath (DE)

(73) Assignee: Brose Fahrzeugteile SE & Co. Kommanditgesellschaft, Bamberg, Bamberg (DE)

(21) Appl. No.: 17/746,515

(22) Filed: May 17, 2022

(30) Foreign Application Priority Data
May 18, 2021 (DE) 10 2021 112 846.3

(51) Int. Cl. B60N 2/02

(52) U.S. Cl. CPC B60N 2/0244; B60N 2/0232

(57) ABSTRACT

A control arrangement for a drive arrangement of a motor vehicle interior element, the interior element is adjustable and lockable in position by aid of adjustment kinematics, the drive arrangement configured to adjust the interior element with the aid of adjustment kinematics and an interior sensor arrangement for detecting an object, the control arrangement activates the drive in an adjustment routine to adjust the interior element in a rotational motion from an initial angle to a terminal angle. The control arrangement activates the adjustment routine based on sensor data for the object, acquired by means of the interior sensor. The control arrangement includes an interior-element model of geometry of the interior element and the adjustment kinematics and generates a geometric object model based on the sensor data, to determine the terminal angle based on the interior-element model and the object model, adhering to a separation specification.

### CROSS-REFERENCE TO RELATED APPLICATIONS

This application claims priority to German Patent Application No. DE 10 2021 112 846.3, filed on May 18, 2021, the disclosure of which is hereby incorporated in its entirety by reference herein.

### TECHNICAL FIELD

The present disclosure relates to a control arrangement for a drive arrangement of a motor vehicle.

### BACKGROUND

With a view to enhancing comfort, motor vehicles are equipped with motor-adjustable interior elements. Such interior elements have been designed, for instance, as seats, bench seats, consoles or as further components such as operating elements, blinds, lighting elements, interior mirrors or such like. The drive arrangements under discussion here may relate to the motorized adjustment of several such interior elements.

### SUMMARY

The problem underlying the present disclosure is to design and to develop further the known control arrangement for a drive arrangement in such a manner that space within the vehicle is improved after interior elements are adjusted.

Space within a vehicle interior may be improved or optimally utilized, while preventing collisions between interior elements, if the detection of the object is drawn upon for the purpose of establishing the terminal angle of the motorized adjustment, particularly in advance.

Here, an interior-element model and also an object model are utilized, in order to achieve a motorized adjustment that is as extensive as possible, taking the separation specification into consideration.

In detail, it is proposed that the control arrangement possesses a predetermined interior-element model of the geometry of the interior element and of the adjustment kinematics, such that the control arrangement generates a geometric object model of the object on the basis of the sensor data, and that the control arrangement determines the terminal angle of the adjustment routine on the basis of the interior-element model and the object model, adhering to a separation specification.

### BRIEF DESCRIPTION OF THE DRAWINGS

In the following, the invention will be elucidated in more detail with reference to a drawing merely representing embodiments. Shown in the drawing are:

FIG. 1 in a), a schematic side view of a motor vehicle; in b), interior elements in a first seat configuration; and in c), interior elements in a further seat configuration.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A known control arrangement for a drive arrangement is provided in DE 10 2019 108 601 A1.

The focus of attention here is a rotational motion, in particular a folding motion of an interior element—for instance, a backrest of a seat. The operator of the motor vehicle can trigger a motorized adjustment manually and, in particular, have recourse to preset positions of the interior elements—for instance, predetermined terminal angles for folded-away seats, or orientations of swivel seats in the direction of travel, laterally and contrary to the direction of travel.

However, with the motorized adjustment of the interior elements there is also a risk of a collision of the moving interior element with objects deposited in the interior. The known control arrangement (DE 10 2019 108 601 A1), includes a recourse to sensor data pertaining to a distance sensor, in order to prohibit the adjustment when a possible collision with an object is detected.

Consequently, damage to objects or injury to occupants as a result of the adjustment can be avoided with a high degree of certainty. One challenge in this connection, however, is that in many cases the space remaining in the interior for motorized adjustment is not fully exploited.

The drawing shows a control arrangement 1 according to the proposal and also a drive arrangement 2 according to the proposal for motorized adjustment of an interior element 3, 4, 5 of a motor vehicle 6.

As an example, the drive arrangement 2 has been set up to adjust the interior elements 3, 4, 5, which are designed as seats, between various seat configurations.

The embodiment that is represented in the figures and preferred to this extent relates to a control arrangement 1 for a drive arrangement 2 for motorized adjustment of an interior element 3, 4, 5 of a motor vehicle 6, the interior element 3, 4, 5 being adjustable and capable of being locked in position with the aid of adjustment kinematics 13, the drive arrangement 2 exhibiting at least one drive 7-12, for motorized adjustment of the interior element 3, 4, 5 with the aid of the adjustment kinematics 13, and also an interior sensor arrangement 14 for detecting an object 19 in the interior 18 of the motor vehicle 6, the control arrangement 1 activating the drive 7-12 in an adjustment routine in order to move the interior element 3, 4, 5 with the aid of the adjustment kinematics 13 in a rotational motion, preferentially a folding motion, from an initial angle to a terminal angle, the control arrangement 1 undertaking the activation in the adjustment routine in a manner depending on sensor data for the object 19, acquired by means of the interior sensor arrangement 14.

The control arrangement 1 may be an integral part of a central motor-vehicle control system or may have been designed as a decentralized control arrangement for the motor vehicle 6. The control arrangement 1 preferentially exhibits control electronics for implementing the control tasks arising in the adjustment routine.

As an example, several interior elements 3, 4, 5, which possess respective drives 7-12, have been provided for adjustment. By the “adjustment kinematics 13”, the components of the interior element 3, 4, 5 that enable a motion of the interior element 3, 4, 5—for instance, joints, hinges, guide rails or such like—are to be understood. The adjustment kinematics 13 may permit an adjustment of individual components of an interior element 3, 4, 5 relative to one another—for instance, for the purpose of adjusting the seat back with respect to the seat surface, perhaps by way of a folding motion, and/or may permit an adjustment of the interior element 3, 4, 5 with respect to the motor-vehicle body, for instance in a rotational motion of a seat and/or for longitudinal adjustment of the seat.

In this connection, individual interior elements 3, 4, 5 may exhibit several drives 7-12 which, in particular, implement various degrees of freedom of the adjustment of the interior element 3, 4, 5. The drives 7-12 are preferentially electromotive drives.

The interior element 3, 4, 5 is capable of being locked in position, in particular with the aid of a self-locking drive 7-12 and/or with the aid of a mechanical latching device with which, after an adjustment, the interior element 3, 4, 5 remains automatically in the position attained. The mechanical latching device preferentially exhibits latching means such as latching bolts, interlocking toothed disks or such like, which can be released by means of the drive arrangement 2. The latching means may, in addition, have been mechanically biased, in particular into the latched position, perhaps with the aid of spring elements.

The interior sensor arrangement 14 as an example, exhibits several interior sensors 15, 16, 17 which have been designed to acquire spatial information pertaining to objects 19 located in the interior 18. The interior sensors 15, 16, 17 may each be a radar sensor, an optical sensor, for instance a camera such as a ToF camera and/or 3D camera, an acoustic sensor, for instance an ultrasonic sensor or such like.

As an example, the adjustment routine relates to at least one interior element 4, 5 designed as a rear seat, more preferentially in the second and/or third row of seats of the motor vehicle 6. In one design, the rotational motion relates to a rotation of the entire interior element 4, 5, or about an approximately vertical swivel axis, for the purpose of adjusting the orientation of the interior element 4, 5. A folding motion may take place into a folded-down position of the interior element 3, 4, 5. However, an adjustment into a folded-upright position and/or the adjustment of other interior elements is/are also conceivable, in which respect reference is made, in supplement, to the introductory statements.

In the adjustment routine the interior element 4, 5 is adjusted—here, with the aid of the adjustment kinematics 13—in a rotational motion from an initial angle to a terminal angle. The adjustment kinematics 13 consequently permit a swivel motion—for example, a swiveling of the seat back with respect to the seat surface—about a geometric swivel axis predetermined by the adjustment kinematics 13.

By the “adjustment angle” which is to be transformed from the initial angle into the terminal angle, in this connection the angle of the interior element 3, 4, 5 and/or of the component of the interior element 3, 4, 5 that is capable of swiveling—here, the seat back—about the geometric swivel axis is understood. In a further design, the rotational motion—in particular, the folding motion—can be combined with a longitudinal motion.

Now it is essential that the control arrangement 1 possesses a predetermined interior-element model of the geometry of the interior element 3, 4, 5 and of the adjustment kinematics 13, that the control arrangement 1 generates a geometric object model of the object 19 on the basis of the sensor data, and that the control arrangement 1 determines the terminal angle of the adjustment routine on the basis of the interior-element model and the object model, adhering to a separation specification.

The interior-element model is representative of the extent of the interior element 3, 4, 5 as a function of the position of the interior element 3, 4, 5 implemented with the aid of the adjustment kinematics 13. The interior-element model maps, for instance, the location of the surfaces of the interior element 3, 4, 5 at various adjustment angles and at various longitudinal positions of the interior element 3, 4, 5 into a coordinate system assigned to the interior 18.

The object model is representative of the location and, for example the shape of the object 19. In one design, the location of the surface of the object 19 is captured—for instance, point by point—by means of the interior sensor arrangement 14 and, in turn, is mapped in a coordinate system assigned to the interior 18. It is conceivable that the object model is based on a simplified shape of the object 19—for instance, on an enveloping body such as a bounding box, a bounding sphere or such like.

The separation specification generally contains an indication of the extent to which a separation between interior element 3, 4, 5 and object 19 has to be adhered to, and/or a contact between interior element 3, 4, 5 and object 19 is to occur.

On the basis of the interior-element model and the object model, by means of the control arrangement 1 a terminal angle is correspondingly determined, with which the separation specification is still adhered to, in which connection the adjustment is to be carried out as extensively as possible, such as at the same time. With the interior-element model and the object model, a prognosis can be generated concerning the position of the interior element 4, 5 at which the separation specification is still adhered to.

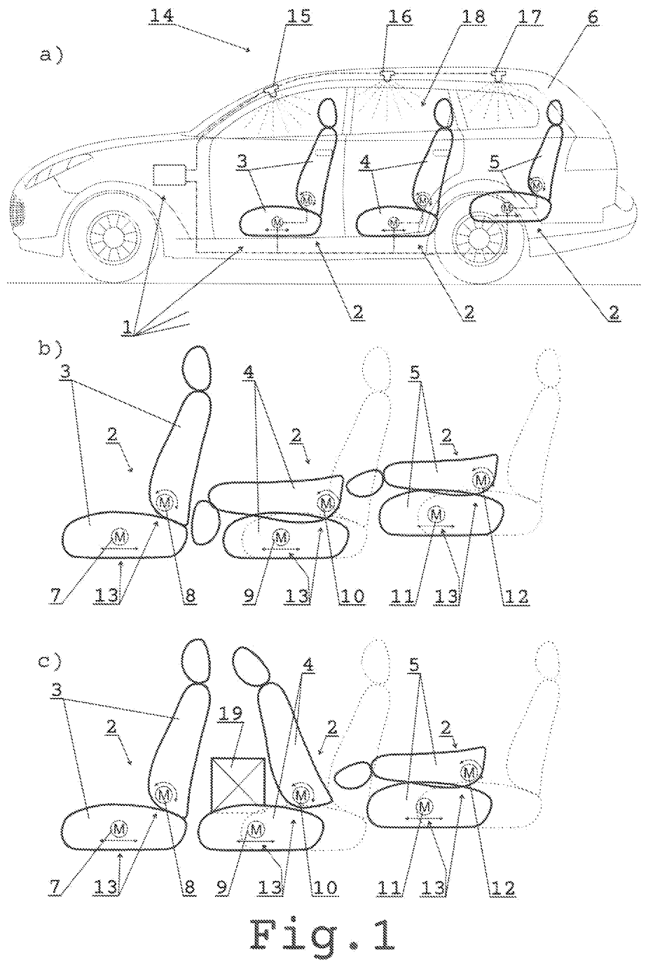

In FIG. 1b) an adjustment is provided, in exemplary manner, of the interior elements 4, 5 from an initial angle, which corresponds to an upright position of the seat backs (dotted lines), to a terminal angle which corresponds to a folded-down position of the seat backs (solid lines). The terminal angle may be part of an operator default stored in the control arrangement 1, with which the interior elements 4, 5 are brought into a folded-down position. In FIG. 1b) there is no object 19 in the path of adjustment of the interior elements 4, 5, so here the terminal angle according to the operator default is attained with the adjustment.

In FIG. 1c), on the other hand, an adjustment of the interior elements 4, 5 with an object 19 in the interior 18 has been represented in exemplary manner. The object 19 is detected by means of the interior sensor arrangement 14, and the control arrangement 1 generates an object model on the basis of the acquired sensor data. The control arrangement 1 ascertains the terminal angle that can be attained by the seat back of the adjustment element 4, adhering to the separation specification, and uses the ascertained terminal angle in the adjustment routine.

The adherence to the separation specification can also be monitored by a sensory determination of the separation between interior element 3, 4, 5 and object 19 in the adjustment, in particular by means of the interior sensor arrangement 14.

In FIG. 1b) and FIG. 1c) an additional longitudinal adjustment of the interior elements 4, 5 is shown, which can also be undertaken in a manner depending on the object model and the interior-element model.

In one or more embodiments, the sensor data the control arrangement 1 classifies the object 19 in a predetermined object class with a separation specification assigned to the object class, and that the control arrangement 1 determines the terminal angle in accordance with the separation specification that has been assigned to the object class of the object 19, such that that the interior sensor arrangement 14 exhibits several interior sensors 15, 16, 17 of diverse sensor types, on the basis of the sensor data of which the object 19 is classified.

The classification may be carried out on the basis of a pattern-recognition, for instance an image-recognition, on the basis of the size of the object 19 and/or in a manner depending on a motion of the object 19. As an example, radar sensors and/or optical sensors of the interior sensor arrangement 14 can be drawn upon for the pattern-recognition.

By “several interior sensors 15, 16, 17 of diverse sensor types”, in this connection interior sensors 15, 16, 17 having diverse fundamental measuring principles are understood—for instance, a combination of an optical sensor with a pressure sensor or such like. In particular, a classification can be carried out with the aid of a pattern-recognition, this classification being validated with the aid of sensor data pertaining to a pressure sensor on the interior element 4, 5.

Moreover, there is provision for example, that the separation specification has been defined, at least partially, in that a predetermined minimum separation between interior element 3, 4, 5 and object 19 is adhered to, or that a contact between interior element 3, 4, 5 and object 19, such as a predetermined deformation of the object, takes place, such as that the minimum separation and/or the deformation of the object has/have been predetermined in a manner depending on the object class of the object 19, or that a minimum separation greater than zero has been predetermined for a “living being” object class, or the control arrangement 1 suppresses the adjustment routine in response to a classification of the object 19 in the “living being” object class.

The minimum separation and the deformation of the object can be predetermined in straightforward manner on the basis of the classification, in which connection various minimum separations or deformations of the object may have been stored for various object classes, depending upon the respective safety requirements for the object class.

As an example, a greater minimum separation, for instance of at least 10 cm, has been predetermined for a “living being” object class than for object classes of inanimate objects 19 which require a smaller minimum separation or no minimum separation. In the case of object classes without a minimum separation, a contact or even a deformation may have been predetermined, such as once again in a manner depending on the respective object class.

In addition, there is provision, for example, that the control arrangement 1 ascertains the adjustment angle of the adjustment kinematics 13 in the adjustment routine on the basis of the sensor data and/or on the basis of drive values of the drive arrangement 2, and/or that in the adjustment routine the control arrangement 1 monitors the adherence to the deformation of the object specified by the separation specification on the basis of the sensor data.

In addition to the detection of objects 19 deposited in the interior 18, the interior sensor arrangement 14 is employed here with a dual use to determine the adjustment angle of the adjustment kinematics 13.

A determination of the adjustment angle with the aid of drive values can be carried out, in particular, on the basis of an incremental position sensor of the drive 7-12 and/or on the basis of drive-current values in the case of known kinematics of the adjustment kinematics 13.

The determination of the adjustment angle can be undertaken before the motorized adjustment, such as for the purpose of ascertaining the output angle, and/or during the adjustment.

A contact and/or deformation can, in turn, be monitored by further sensorics, for instance pressure sensors in the interior element 3, 4, 5. Upon detection of a contact, in particular the motorized adjustment can be terminated, as a result of which an additional degree of security in the course of the adjustment is achieved.

In one or more embodiments, a drive arrangement 2 for motorized adjustment of an interior element 3, 4, 5 of a motor vehicle 6, the interior element 3, 4, 5 being adjustable and capable of being locked in position with the aid of adjustment kinematics 13, the drive arrangement 2 exhibiting at least one drive 7-12 for motorized adjustment of the interior element 3, 4, 5 with the aid of the adjustment kinematics 13, an interior sensor arrangement 14 for detecting an object 19 in the interior 18 of the motor vehicle 6, and also a control arrangement 1.

Reference is made to all the statements relating to the control arrangement 1 according to the proposal.

Disclosed, in addition, is a motor vehicle 6 with the drive arrangement 2 according to the proposal as such, which exhibits at least one interior element 3, 4, 5, the drive arrangement 2 having been assigned to the interior element 3, 4, 5.

Furthermore, a method is disclosed for operating a drive arrangement 2 for motorized adjustment of an interior element 3, 4, 5 of a motor vehicle 6 using a drive arrangement 2 according to the proposal as such. Reference is made to all the above statements concerning these further disclosures.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### LIST OF REFERENCE NUMBERS

1 control arrangement

2 drive arrangement

3 interior element

4 interior element

5 interior element

6 motor vehicle

13 adjustment kinematics

14 interior sensor arrangement

15 interior sensors

16 interior sensors

17 interior sensors

18 interior

19 object

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A control arrangement for a drive arrangement configured to provide motorized adjustment of an interior element for use in a motor vehicle, the interior element is adjustable and configured to be locked in one or more positions with the aid of adjustment kinematics, the control arrangement comprising:
a controller,
wherein the drive arrangement includes
a drive configured to provide motorized adjustment of the interior element with the aid of the adjustment kinematics, and
an interior sensor arrangement configured to detect an object disposed in the interior of the motor vehicle,
wherein the controller is configured to execute an adjustment routine, in which the controller activates the drive to adjust the interior element with the aid of the adjustment kinematics so that the interior element rotates from an initial angle to a terminal angle,
wherein the controller is configured to execute the adjustment routine based on sensor data for the object, received from the interior sensor arrangement,
wherein the controller includes a predetermined interior-element model of geometry of the interior element and the adjustment kinematics, and the controller is further configured to generate a geometric object model of the object based on the sensor data, determine the terminal angle based on the interior-element model and the object model and adhere to a separation specification.

2. The control arrangement of claim 1, wherein the controller is configured to classify the object to a predetermined object class based on the sensor data, wherein the separation specification is assigned to the object class, and
wherein the controller is further configured to determine the terminal angle based on the separation specification assigned to the predetermined object class of the object and the sensor data associated with the object.

3. The control arrangement of claim 1, wherein the separation specification is at least partially defined, to provide a predetermined minimum separation between interior element and the object.

4. The control arrangement of claim 1, wherein the controller is further configured determine an adjustment angle of the adjustment kinematics based on the sensor data.

5. A drive arrangement configured to provide motorized adjustment of an interior element of a motor vehicle, wherein the interior element is adjustable and configured to lock in one or more positions with the aid of adjustment kinematics, the drive arrangement comprising:
at least one drive configured to provide motorized adjustment of the interior element with the aid of the adjustment kinematics;
an interior sensor arrangement configured to detect an object disposed in the interior of the motor vehicle; and
a controller programmed with a predetermined interior-element model of geometry of the interior element and the adjustment kinematics, wherein the controller is configured to,
command the drive arrangement to adjust the interior element from an initial angle to a terminal angle,
generate a geometric object model of the object based on sensor data received from the interior sensor arrangement, and
determine the terminal angle based on the interior-element model and the object model.

6. The control arrangement of claim 1, wherein preferentially a folding motion wherein the interior element is configured to fold as the interior element rotates.

7. The control arrangement of claim 2, wherein the interior sensor arrangement includes a number of interior sensors including the interior sensor, wherein the number of interior sensors are different types of sensors.

8. The control arrangement of claim 3, wherein the separation specification is at least partially defined to provide a contact between the interior element and the object.

9. The control arrangement of claim 8, wherein the separation specification is at least partially defined so that the interior element or the object is at least partially deforms by a predetermined amount.

10. The control arrangement of claim 8, wherein the controller is configured to classify the object as a “living being” object class, and the controller is further configured to define the predetermined minimum separation as a value greater than zero in response to the object being classified as the “living being” object class.

11. The control arrangement of claim 10, wherein the controller is configured to suppress execution of the adjustment routine in response to the object being classified as the “living being” object class.

12. The control arrangement of claim 1, wherein the controller is further configured to determine an adjustment angle of the adjustment kinematics based on drive values of the drive arrangement.

13. The control arrangement of claim 9, wherein the controller is further configured to monitor deformation of the object based on the sensor data.

14. The drive arrangement of claim 5, wherein the controller is configured to command the drive arrangement to rotate the interior element.

15. The drive arrangement of claim 5, wherein the controller is further configured to command the drive arrangement so that the motorized adjustment of the interior element complies with a separation specification.

16. The drive arrangement of claim 15, wherein the separation specification is at least partially defined to provide a predetermined minimum separation between interior element and the object.

17. The drive arrangement of claim 15, wherein the separation specification is at least partially defined to provide a contact between the interior element and the object.

18. The drive arrangement of claim 15, wherein the separation specification is at least partially defined so that the interior element or the object is at least partially deforms by a predetermined amount.

19. The drive arrangement of claim 15, wherein the controller is further configured to classify the object to an object class of a number of object classes and the separation specification is at least partially based on the object class.

20. The drive arrangement of claim 15, wherein the controller is further configured to prevent the drive arrangement from adjusting the interior element in response to the object being classified as a living being class.
